(19) United States
(12) Patent Application Publication
(10) Pub. No.: US 2026/0341747 A1
(43) Pub. Date: Oct. 29, 2026

(54) BIPOLAR PLATE, BIPOLAR PLATE SYSTEM, END PLATE, AND FUEL CELL

(71) Applicant: KAMAX Holding GmbH & Co. KG, Homberg (Ohm) (DE)

(72) Inventors: Dennis Dutenhöfner, Homberg (Ohm) (DE); Stefan Wallmeier, Goldbach (DE); Claudia Pöggeler Ribas, Marburg (DE); Alexander Hochgesand, Bad Nauheim, Steinfurth (DE)

(73) Assignee: KAMAX Holding GmbH & Co. KG, Homberg (Ohm) (DE)

(21) Appl. No.: 18/998,965

(22) PCT Filed: Jul. 11, 2023
(86) PCT No.: PCT/EP2023/069180

§ 371 Date: Jan. 27, 2025

(30) Foreign Application Priority Data
Jul. 29, 2022 (DE) 102022119087.0
Nov. 29, 2022 (DE) 102022131561.4
Nov. 29, 2022 (DE) 102022131562.2

(51) Int. Cl. H01M 8/0263; H01M 8/0276; H01M 8/0297

(52) U.S. Cl. CPC H01M 8/0263; H01M 8/0276; H01M 8/0297

(57) ABSTRACT

Bipolar plate (210) for a fuel cell (1), wherein the bipolar plate (210) extends in a longitudinal direction (L) and in a width direction (B), wherein the longitudinal direction (L) and the width direction (B) are in particular perpendicular to one another, wherein the bipolar plate (210) has a plurality of openings (240), wherein the openings (240) have an outer contour, wherein the outer contour of the openings (240) is formed in each case by a mounting opening (242) and at least one flow opening (244), wherein the mounting opening (242) forms a circular-segment-shaped part of the outer contour of the opening (240), and wherein the mounting opening (242) is designed to accommodate a fastener (9).

### CROSS-REFERENCE TO RELATED APPLICATIONS

This application is a U.S. National Stage Application under 35 U.S.C. § 371 of International Application No. PCT/EP2023/069180, filed Jul. 11, 2023, which claims the benefit of and priority to German Patent Application Nos. DE 10 2022 119 087.0, filed Jul. 29, 2022, DE 2022 131 561.4, filed Nov. 29, 2022, and DE 10 2022 131 562.2, filed Nov. 29, 2022, the contents of which are hereby incorporated herein by reference in their entireties.

### TECHNICAL FIELD

The invention relates to a bipolar plate, a bipolar plate system, an end plate and/or a fuel cell.

### BACKGROUND

Fuel cells are already known from the state of the art. They are used to release electrons, in particular by means of a reaction, in order to generate a current flow or provide energy. Various fluids can be used as fuel, e.g. hydrogen. The problem with the known systems, however, is that the fuel cells consist of several cells that are separated from each other by bipolar plates. These cells are usually arranged in stacks and covered at the end by an end plate in order to achieve a compact design. The cells are usually fixed to each other and to the end plate using an external fastener. However, this exposes the bipolar plates and the end plate to high bending stresses and/or results in a high installation space requirement.

### SUMMARY

It is therefore the task of the invention to provide a space-saving arrangement which nevertheless enables the components of the fuel cell to be securely fixed.

This problem is solved with a bipolar plate according to claim 1, with a bipolar plate system according to claim 4, with an end plate according to claim 8 and with a fuel cell according to claim 10. Further advantages, features and embodiments are shown in the sub-claims, the description and the figures.

According to the invention is a bipolar plate. The bipolar plate is used to form or be able to form part of a fuel cell. The bipolar plate extends in a longitudinal direction and in a width direction, wherein the longitudinal direction and the width direction are in particular perpendicular to one another, wherein the bipolar plate has a plurality of openings, wherein the openings have an outer contour, wherein the outer contour of the openings is formed in each case by a mounting opening and at least one flow opening, wherein the mounting opening forms a circular-segment-shaped part of the outer contour of the opening, and wherein the mounting opening is designed to hold a fastening or connector. The bipolar plate is a part of and/or can be arranged or used in a fuel cell. In particular, an MEA is arranged between two bipolar plates. An MEA is a membrane electrode assembly within the meaning of the invention. The bipolar plates therefore serve to be able to feed fuel, in particular hydrogen, and/or oxygen and/or combustion products, in particular fluids, e.g. water or water vapour, from and/or to the MEA and at the same time at least partially to limit the intake volume for the MEA. Furthermore, the bipolar plates can be used in particular to conduct electrons. In particular, the bipolar plates are at least partially made of a conductive material and/or of plastic and/or at least partially of an insulating material. The bipolar plates can therefore form part of a stack or a “bag” of a fuel cell. The bipolar plates extend in particular in a longitudinal direction and in a width direction. The longitudinal direction is in particular the direction in which the bipolar plate has its largest main dimension. The width direction, on the other hand, can in particular be the direction in which the width of the bipolar plate is measured. Perpendicular to the longitudinal direction and/or the width direction is a height direction. In particular, the height direction can be the direction in which the material thickness of the bipolar plate is measured. It is particularly expedient for the longitudinal direction and the width direction to be perpendicular to each other. Furthermore, the longitudinal direction, the width direction and the height direction can be perpendicular to each other. In other words, the longitudinal direction, the width direction and the height direction can form a right-angled coordinate system with each other. The bipolar plate has a large number of openings. These openings penetrate the bipolar plate completely, whereby the main direction of the openings is in particular the height direction. In other words, the openings penetrate the bipolar plate in a vertical direction. This makes it possible to guide fittings, in particular fasteners and/or connectors, and/or fluids through the bipolar plate. In other words, the openings can therefore serve to allow a fluid to flow from one side of the bipolar plate to the other side of the bipolar plate and also simultaneously provide a space to accommodate fasteners or clamps. The flow openings of the openings are intended in particular to guide the fluid. The openings themselves are formed by one component, which is the flow opening, and at least one other component, which is referred to as the mounting opening. The mounting opening serves to accommodate a fastener or connector, which can also be a clamp or connector to allow clamping of the bipolar plate and/or the stacks of the fuel cell. In other words, the opening can therefore be formed by a combination of a mounting opening and at least one flow opening. The bipolar plate is expediently equipped with a large number of openings, each of which has at least one flow opening and one mounting opening. The openings are arranged or designed in such a way that they form an outer contour on the bipolar plate. The outer contour is in particular the outer edge of the opening on a surface bordering the bipolar plate, in particular in the vertical direction. This outer contour of the opening or openings is formed at least in sections by the flow opening and at least in sections by the mounting opening. In other words, the edge of the opening is formed at least partially by the mounting opening and at least partially by the flow opening. In particular, the mounting opening forms a circular-segment-shaped part of the outer contour of the opening. In other words, at least part of the outer opening is therefore formed by a circular section, which also delimits the mounting opening. Alternatively, the opening can have a section in the shape of a semi-circular segment, which is just formed by the mounting opening. This makes it possible to achieve a particularly low fatigue notch factor and a compact design of the mounting opening that is favourable for production, in particular adapted to a fastener or connector, in particular a fastener and/or connector in the form of a screw. A screw within the meaning of the invention can in particular be a fastener and/or connector which has an actuation head and/or an actuation section and furthermore has an external thread and/or an internal thread, which in particular is in a shank section.

In a preferred embodiment, the bipolar plate has a flow area, wherein the flow area serves to delimit a fluid volume, in particular subsequently/later, wherein the fluid volume is or can be in fluid connection with at least two openings. The flow area is in particular the area of the bipolar plate or the outer surface or surfaces of the bipolar plate in the vertical direction, which is or can later be brought into fluid contact with the MEA. The flow area can therefore form or be or comprise a surface on the bipolar plate. Expediently, the bipolar plate has both a flow area, which is formed by a surface bordering the positive height direction, and a flow area, which is formed by a surface bordering the negative height direction. In particular, the flow area is later used to limit the fluid volume that is in communication with the MEA and/or at least partially to provide the volume in which the MEA is arranged. The flow area therefore borders a fluid volume in particular, which is or can be in fluid connection with at least two openings in the bipolar plate. This can be particularly important if a sealing element is later arranged and/or arranged on the bipolar plate, which allows a fluid flow from the opening to the flow area and from the flow area to another opening. In this way, the openings, in particular the flow inlets of the openings, which are in fluid connection with the flow area or the fluid volume, can be used to achieve an inflow and outflow of fluids into the fluid volume.

Expediently, the mounting opening and the flow opening of an opening or openings penetrate the bipolar plate. This makes it particularly easy to feed a fastener and/or connector and a flow fluid through the bipolar plate.

Advantageously, the flow opening is designed in such a way that it extends from the mounting opening to the flow area in the plane spanned by the longitudinal and width directions. In this way, a particularly favourable fluidic design of the flow opening can be achieved.

Expediently, the circular-segment-shaped part of the mounting opening forms at least 51%, preferably at least 65%, and particularly preferably at least 75% of a circle. In other words, the circular-segment-shaped part can form at least 51% of a complete circle, preferably at least 65% of a complete circle, and particularly preferably at least 75% of a complete circle. A design such that at least 51% is formed by the circular-segment-shaped part of the mounting opening can secure the position of the fastener/connector accommodated in the circular-segment-shaped part or in the mounting opening. In other words, such a design can in particular ensure positive locking of a fastener/connector within the mounting opening or at least provide it in an emergency, so that in particular slipping of the bipolar plate in relation to the fastener/connector in a longitudinal and lateral plane is prevented or can be prevented by positive locking. To further improve this positive locking, the circular-segment-shaped part should form at least 65%, preferably at least 75% of a complete circle. This allows the positive locking between the bipolar plate and a fastener/connector to be further improved in order to achieve better positional accuracy. This type of positive locking of the bipolar plate relative to the fastener/connector makes it particularly easy to install. It makes it possible, in particular, to thread the individual bipolar plates onto the fastener/connector at a later stage, thus simplifying mounting.

Preferably, however, the circular-segment-shaped part of the mounting opening forms a maximum of 98%, preferably a maximum of 90%, and particularly preferably a maximum of 80%, of a circle. The parts that are missing to form a complete circle belong in particular to the flow opening. In other words, such a design can ensure that there is sufficient space for the flow opening in the opening so that a sufficient flow area or flow option is provided.

Preferably, the bipolar plate has flow grooves, in particular in one or the flow area of the bipolar plate, with the flow grooves ending and/or starting in particular in an opening. In other words, the bipolar plate can have grooves, in particular in a surface which delimits the bipolar plate in the height direction, which favour and/or can achieve fluid flow. These grooves are, in particular, called flow grooves. Expediently, these flow grooves run along the bipolar plate or are arranged on the bipolar plate in such a way that they end and/or start in an opening, in particular in a flow opening. In other words, the grooves extend into the flow opening or the opening. This makes it possible to achieve a particularly favourable fluidic connection of the flow grooves. By providing the flow grooves, blockage and a uniform supply of fluids into the MEA can be achieved.

In a preferred embodiment, the flow grooves are formed by straight and/or rectangular sections and/or the flow grooves are meandering. By using only straight and/or rectangular or right-angled sections and/or a meandering design, the flow groove has a particularly large extension. This enables a particularly effective and homogeneous supply of fluids and/or discharge of fluids into and/or out of the MEA into the flow grooves. Due to the meandering design of the flow groove, a particularly long flow length of the grooves can also be achieved and thus a particularly homogeneous supply or discharge of fluids from and/or into the MEA.

Advantageously, the part of the outer contour of the opening that is formed by the flow opening is further away from the centre of gravity of the opening or from the centre of the circular-segment-shaped part than the part of the outer contour of the opening that is formed by the mounting opening. In other words, the flow opening can extend away from the otherwise circular mounting opening like an extension. Alternatively or additionally preferably, the mounting opening forms all circular-segment-shaped parts of the opening and/or is formed exclusively by circular-segment-shaped parts, which in particular all have the same centre point. These types of design of the opening, some of the openings, the majority of the openings and/or all of the openings can create a particularly good fluid routing option. The centre of the circular-segment-shaped part is, in particular, the point around which the radius of the circular-segment-shaped part is determined or the point which is the same distance from all points of the circular-segment-shaped part.

Preferably, the bipolar plate has a width to length ratio of in particular less than or equal to 1 to 3, wherein the bipolar plate has an opening, in particular a plurality of openings, in its centre area in the longitudinal direction. In other words, the dimension of the bipolar plate in the width direction in relation to the dimension of the bipolar plate in the length direction can be a ratio of less than or equal to 1 to 3. If such a ratio is present, an opening, in particular a plurality of openings, can be provided in a central area in the longitudinal direction. The central area in the longitudinal direction is in particular that area of the bipolar plate in the longitudinal direction which extends in the longitudinal direction from the ideal centre point by +/−25%, preferably +/−15%, and particularly preferably +/−10%, and most preferably +/−5% of the maximum length of the bipolar plate in the longitudinal direction. The centre of the bipolar plate is in particular the centre of volume or the centre of gravity of the bipolar plate. The arrangement of an opening, in particular a plurality of openings, as also described above and below, in the central area makes it possible to achieve particularly good bracing of the bipolar plate. In particular, bending moments due to the bracing can be avoided or reduced by the arrangement of an opening in the central area. Advantageously, all of these openings are designed as described above or below, in particular the openings therefore have mounting openings and flow openings, whereby a fastener/connector in particular is guided or can be guided through the flow opening.

A further aspect of the invention may relate to a use of a bipolar plate in/for a fuel cell.

A further aspect of the invention may relate to a bipolar plate system. In particular, the bipolar plate system comprises a bipolar plate as described above and/or below, and a sealing element, in particular a sealing ring. It is expedient if the sealing element lies against the bipolar plate, whereby the sealing element follows or can follow the circular-segment-shaped part of the outer contour of an opening at least in sections. The bipolar plate system therefore comprises in particular at least one sealing element, which can be designed as a sealing ring. A sealing ring is a sealing element that is self-contained. In other words, the sealing ring is therefore a sealing element without an end. In particular, the sealing element is in contact with the bipolar plate; this can be achieved in particular by direct contact between the sealing element and the bipolar plate. Ideally, this contact or contact area of the sealing element with the bipolar plate forms a closed contour. In other words, the sealing element can therefore always be in contact with the bipolar plate along its length. Expediently, the sealing element follows the or a circular-segment-shaped part of the outer contour of an opening at least in sections. The following is to be understood in particular as meaning that the projection of the sealing element and the projection of the outer contour on a plane which is spanned by the longitudinal direction and the width direction overlap and/or that the course of the sealing element and the outer contour is the same at least in the following area and/or the sealing element abuts the circular-segment-shaped part of the outer contour at least in sections. As the sealing element follows the outer contour of the opening in the circular-segment-shaped part, it is possible to achieve a particularly short length of the sealing element and also a strong sealing effect.

In an advantageous embodiment, the sealing element follows at least 40%, preferably at least 60%, and particularly preferably at least 80%, and particularly very preferably at least 90%, and most preferably at least 97% of the circular-segment-shaped part of the outer contour of an opening. Alternatively or additionally preferably, the sealing element follows at least 40%, preferably at least 60%, and particularly preferably at least 80%, and particularly very preferably at least 90%, and most preferably at least 97% of the outer contour of an opening. By following at least 40% of the circular-segment-shaped part and/or the entire outer contour of the opening, particularly simple mounting can be achieved. However, if at least 60% or at least 80% of the circular-segment-shaped part of the outer contour and/or the entire outer contour of the opening is followed by the sealing element, a particularly good sealing effect can be achieved. However, if 90% of the outer contour or the circular part is followed by the sealing element, this can provide particularly good mechanical support around the opening. This capability is particularly noteworthy because, when the bipolar plate is braced by means of a fastener/connector that is guided through the opening, contact forces or tensioning forces can be safely dissipated directly via the sealing element. Following the circular-segment-shaped part of the outer contour of the opening or the outer contour of the opening by at least X per cent is to be understood in particular to mean that at least X per cent of the projection of the outer contour of the circular-segment-shaped part or the entire outer contour on a plane spanned by the longitudinal and width directions overlaps with the projection of the sealing element in this plane and/or that the sealing element abuts at least X per cent of the circular-segment-shaped part of the outer contour or the outer contour.

Advantageously, the sealing element protrudes into the or one opening and/or protrudes into at least two openings. In particular, only the openings that have a mounting opening and a flow opening and/or through which a fastener/connector is guided and/or which serve or are designed to accommodate a fastener are relevant. By projecting inwards, in particular, the seal can be arranged between the fastener/connector and the edge of an opening, so that contact between the fastener/connector and the opening is prevented. In other words, the sealing element can therefore be used to create electronic insulation between the fastener/connector and the bipolar plate.

Expediently, the sealing element is made of an insulating material in particular.

Advantageously, the bipolar plate system has a plurality of sealing elements, wherein the sealing elements follow the course of the outer contour of at least one opening, at least in sections, and/or wherein each opening is surrounded by an outer contour of a sealing element. In particular, the openings that have a mounting opening and a flow opening and/or are designed to accommodate a fastener/connector are relevant for this. Using a design in which the openings and/or at least one of the openings is surrounded by an outer contour of a sealing element means that the opening can be used to guide fluid into and/or out of a fluid volume. Surrounding the opening by an outer contour of a sealing element means, in particular, that in a projection on the plane which is formed by the longitudinal direction and the width direction of the surrounding sealing element and the opening, the outer contour of the projection of the sealing element or the outer edge of this contour sur-rounds and/or contains the outer contour of the opening.

Preferably, the sealing element is fixed to the bipolar plate, in particular in a materially bonded and/or irreversible manner, and/or the sealing element is produced by a screen printing process. The advantage of using a screen printing process lies in particular in cost-effective production of a bipolar plate system with a sealing element. By fixing the sealing element to the bipolar plate, the bipolar plate system can be easily installed. In order to achieve this fixing, the material is bonded, for example by gluing and/or screen printing. Expediently, the sealing element is irreversibly fixed to the bipolar plate so that the connection between the sealing element and the bipolar plate can only be achieved by destroying the connection. This enables a particularly high sealing effect to be achieved.

Advantageously, the sealing element is arranged on the bipolar plate in such a way that the sealing element forms a closed contour on the bipolar plate, wherein at least two flow openings, in particular different openings, and/or the flow area of the bipolar plate is or are advantageously arranged within the closed contour. By providing a closed contour of the sealing element on the bipolar plate, a particularly strong sealing effect can be achieved. The arrangement within the closed contour of at least two flow openings enables a particularly good supply and discharge of fluids into the sealed area. In particular, the flow area of the bipolar plate and/or at least the outlet or the contour of flow openings, in particular of different openings, is also arranged within this sealed area or within the closed contour. This enables a particularly homogeneous or targeted supply and discharge of fluids into the flow area of the bipolar plate.

In a preferred embodiment, the bipolar plate system comprises a fastener/connector wherein the fastener/connector is guided through the opening, in particular through the mounting opening of the opening, wherein the fastener/connector in particular makes contact with the sealing element. The contact between the sealing element and the fastener/connector can provide insulation between the fastener/connector and the bipolar plate. By guiding the fastener/connector through an opening, in particular through the mounting opening of the opening, a particularly simple and space-saving way of bracing and mounting the bipolar plate can be achieved. Expediently, the fastener/connector has an actuation area, in particular a head, and a mounting area, with the mounting area forming a thread. Expediently, the mounting area is formed in and/or around a shaft area of the fastener/connector. The fastener/connector extends in particular in the vertical direction. In other words, the main direction of extension of the fastener/connector is therefore advantageously parallel to the height direction. A fastener/connector is particularly preferably guided through each opening in the bipolar plate which has a mounting opening and a flow opening. This allows particularly homogeneous bracing of the bipolar plate to be achieved.

In a preferred embodiment, the fastener/connector has a flow passage extending along one height direction or the height direction, wherein the flow passage is in fluid connection with the flow opening, which also forms the opening through which the fastener/connector is guided. For example, the fastener/connector can be a banjo, whereby a flow passage can be formed within the banjo. As an alternative preference, the flow passage can also be made externally in the fastener/connector, for example by means of an external groove. The flow passage extends in particular in the vertical direction. In other words, the flow passage can therefore provide fluid transport capability in the vertical direction. This flow passage of the fastener/connector is in particular in fluid connection with the flow opening, so that a fluid can flow from the flow passage into the flow opening. This can provide a particularly effective flow option.

In an alternative or additionally preferred embodiment, the bipolar plate system comprises a plurality of fasteners/connectors, wherein the plurality of fasteners/connectors are each guided through an opening, wherein this opening has, in particular, a mounting opening and/or a flow opening. This allows a particularly homogeneous distribution of tension forces to be achieved, so that ultimately a particularly high sealing effect can be achieved, while at the same time saving valuable installation space.

A further aspect of the invention may relate to the use of a bipolar plate system and/or a fastener/connector in/for a fuel cell.

A further aspect of the invention may relate to an end plate for a fuel cell, wherein the end plate extends in a longitudinal direction and a width direction, wherein the end plate has two mounting areas, in particular spaced apart from one another in the longitudinal direction, wherein the bending stiffness of the end plate, in particular between the mounting areas, is variable, advantageously decreasing in the direction towards the mounting areas. In particular, the end plate extends in a longitudinal direction and a width direction, wherein the longitudinal direction of the end plate can correspond to the longitudinal direction as described above and below and/or the width direction can correspond to the width direction as described above and below. The longitudinal direction of the end plate is in particular the direction in which the end plate has its largest main dimension and/or in which the length of the end plate is determined. The width direction, on the other hand, is in particular the direction in which the width of the end plate is determined and/or in which the end plate has its second largest main dimension. The longitudinal direction and the width direction can in particular be perpendicular to a height direction, in particular this height direction is parallel and/or congruent with the height direction already described above and/or below. The end plate is used in particular in a fuel cell arrangement to form one distal end of the fuel cell, in particular in the vertical direction. In order to mount the end plate, it has two mounting areas that are spaced apart from each other. The mounting areas are in particular areas that serve to provide force transmission to the end plate. Expediently, there is an area in which the end plate has variable bending stiffness between these two mounting areas. In particular, this area with variable bending stiffness is extended in such a way that it comprises and/or forms a centre area in the longitudinal direction of the end plate. The centre area of the end plate is determined in the same way as the centre area of the bipolar plate. It is expedient if the bending stiffness of the area located between the mounting areas is designed in such a way that its bending stiffness decreases in the direction of the mounting areas. Therefore, the bending stiffness in particular is greatest in the area furthest in the longitudinal direction from the mounting areas. Essentially, the end plate can also be referred to as a head plate for the purposes of the invention.

In an advantageous embodiment, the end plate has curved stiffening ribs, with the curved stiffening ribs extending in particular parallel to the longitudinal direction. Expediently, these curved stiffening ribs have a variable height in the longitudinal direction. The curved stiffening ribs are designed in particular in such a way that they have their largest main dimension parallel to the longitudinal direction in order to provide particularly good bending stress absorption.

The end plate, in particular the mounting areas of the end plate, has fixing openings. Particularly preferably, the fasteners/connectors extend through these fixing openings, wherein the fasteners/connectors can in particular also extend through the openings or some of the openings in the bipolar plates.

A further aspect of the invention may relate to the use of an end plate in/for a fuel cell.

A further aspect of the invention may relate to a fuel cell. Expediently, the fuel cell comprises at least one bipolar plate, preferably a plurality of bipolar plates, in particular as described above and/or below. Alternatively or additionally preferably, the fuel cell may also relate to a bipolar plate system, preferably a plurality of polar plate systems and/or a bipolar plate system comprising a plurality of bipolar plates and/or fasteners/connectors and/or sealing elements, in particular as described above and/or below. Furthermore, alternatively or additionally preferably, the fuel cell can also have at least one end plate or two end plates, in particular as described above and/or below.

In a preferred embodiment of a fuel cell, a cavity is formed between and/or in two bipolar plates, said cavity is partially bounded by the flow area of one or both bipolar plates, wherein a fluid enters or can enter the cavity through one of the openings, in particular through a flow opening of the bipolar plate and/or wherein a fluid enters or can enter from the cavity through one of the openings, in particular through a flow opening, of the bipolar plate. In other words, the flow area of the bipolar plate can therefore be in fluid communication with a flow opening of one opening and a flow opening of another opening. This provides a particularly effective and simple way of bringing fluids into contact with the flow area via the flow openings.

In a preferred further development, an MEA is arranged in the cavity. An MEA is a membrane electrode assembly. This allows a particularly compact design of the fuel cell to be achieved.

### BRIEF DESCRIPTION OF THE DRAWINGS

Further advantages and features of the present invention are shown in the following description with reference to the figures. Individual features of the embodiments shown can also be used in other embodiments, unless this has been expressly excluded.

The figures include:

FIG. 1 a bipolar plate;

FIG. 2 a bipolar plate system and/or a bipolar plate;

FIG. 3 a view of an alternative design of a bipolar plate;

FIG. 4 a bipolar plate system with a bipolar plate and a fastener;

FIG. 5 a fuel cell with an end plate and a plurality of bipolar plates and bipolar plate systems; and

FIG. 6 an isometric view of an end plate.

### DETAILED DESCRIPTION

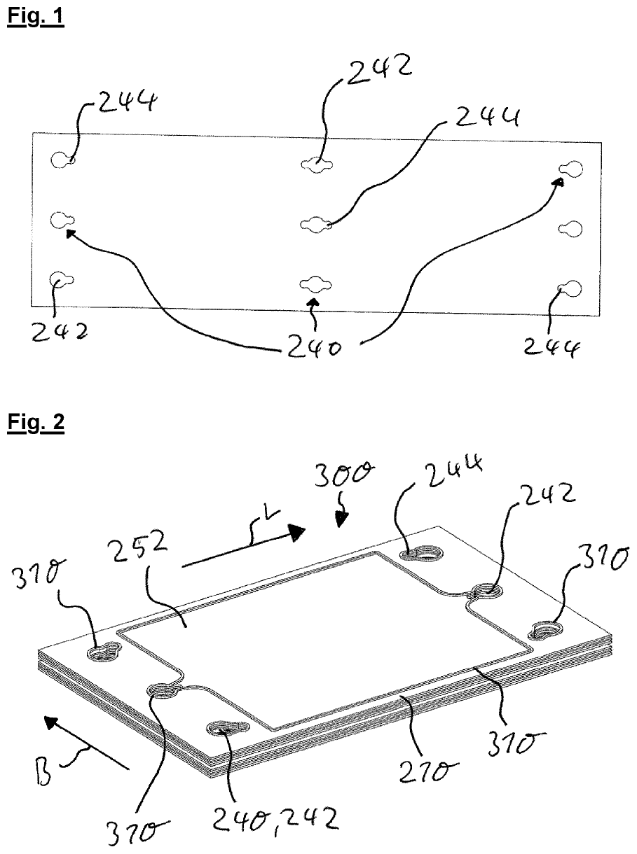

FIG. 1 shows an isometric view of a bipolar plate 210. The bipolar plate 210 has a plurality of openings 240, which extend in the height direction H. The openings 240 each comprise a mounting opening 242 and a flow opening 244. The mounting openings 242 each have a circular-segment-shaped portion and/or form a circular-segment-shaped portion of the outer contour of the opening 240. The mounting opening 242 is designed to accommodate a fastener or a connector. The bipolar plate has a width to length ratio of less than or equal to 1 to 3, whereby a plurality of openings 240 are arranged in the bipolar plate 210 in the central area in the longitudinal direction L. This allows a particularly homogeneous distribution of stress force over the bipolar plate 210.

FIG. 2 shows an isometric view of bipolar plates 210, which are arranged one above the other in the height direction H. A sealing element 310 is arranged between each of the bipolar plates 210. In other words, FIG. 2 shows a bipolar plate system 300. As can be seen from the bipolar plate 210 which is highest in the height direction H, a plurality of sealing elements 310 are fixed on it. These sealing elements 310 each surround an opening 240. Each of the openings 240 comprises at least one mounting opening 242 and one flow opening 244. The sealing element 310 follows at least 60% of the circular-segment-shaped part of the outer contour of each opening 240. The circular-segment-shaped part of the mounting opening 242 forms at least 65% of a circle of the respective openings 240. The flow openings 244 are formed in such a way that they face towards the flow area 252. The flow area 252 is also surrounded by a sealing element 310. Each sealing element 310 protrudes at least partially into an opening 240 or two openings 240, namely at least partially into the mounting opening 242. This can create a particularly good insulation option for a fastener 9, which can be accommodated in the mounting opening 244, as shown in FIG. 4, for example.

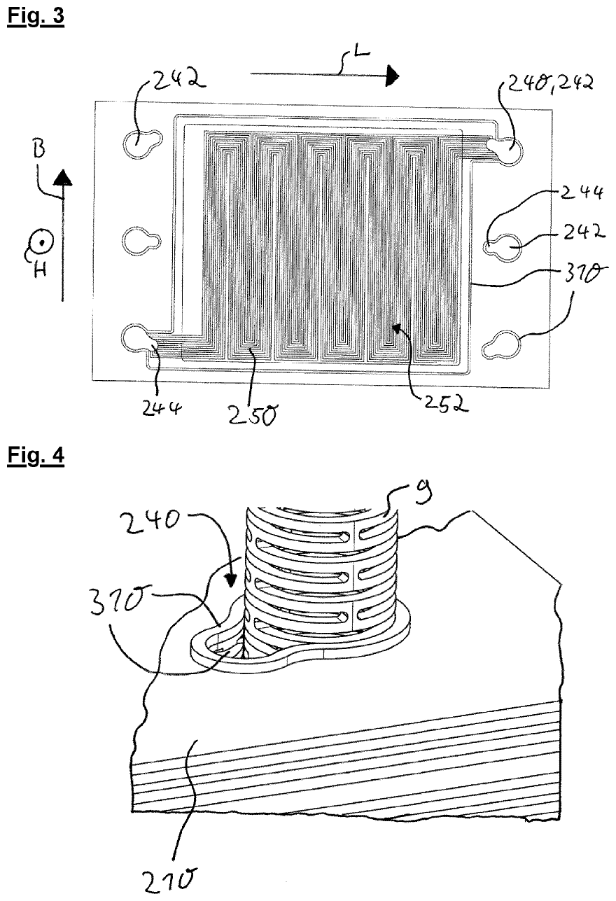

FIG. 3 shows a view of a bipolar plate 210, wherein the bipolar plate 210 has six openings 240 which extend in the height direction H. The width direction B and the longitudinal direction L are perpendicular to the height direction H. The flow grooves 250, which lead through the flow area 252, extend from the opening 240 positioned at the bottom left to the opening 240 positioned at the top right. The flow grooves 250 are arranged in a meandering pattern.

The flow area 252 is surrounded by the sealing element 310, which also sur-rounds two openings 240.

FIG. 4 shows a bipolar plate system 300. The bipolar plate system 300 comprises a plurality of sealing elements 310 and a plurality of bipolar plates 210 and a fastener 9. The fastener 9, which can also be referred to as a connector, extends in the height direction H. As can be seen from FIG. 4, a plurality of sealing elements 310 are in contact with the bipolar plate 210 and the fastener 9. The fastener 9 is designed in such a way that it has a flow passage extending in the height direction H, wherein the flow passage is in fluid connection with the flow opening 244 of the respective openings 240. This enables a particularly good and advantageous fluid supply and/or discharge through the fastener 9.

In FIG. 5, a fuel cell 1 is shown, wherein the fuel cell 1 comprises a plurality of fasteners 9, which may also be referred to as connectors, and a plurality of bipolar plates 210 and/or bipolar plate systems 300. The fuel cell 1 is limited in the height direction H at least in sections by an end plate 500.

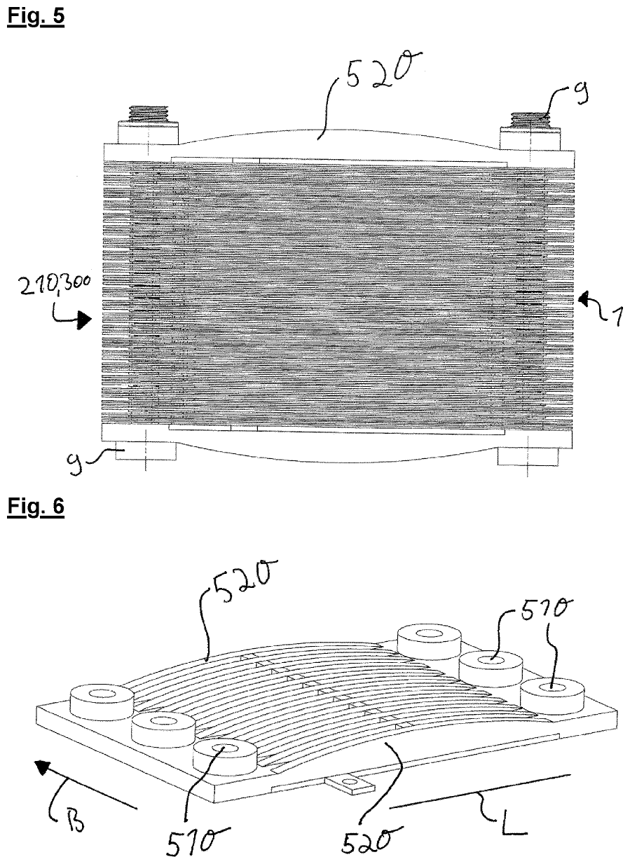

FIG. 6 shows an end plate 500. The end plate 500 extends in the longitudinal direction L and in the width direction B, wherein the end plate 500 has mounting areas 502 spaced apart from one another in the longitudinal direction L, wherein fixing openings 510 are arranged in the mounting areas 502. The mounting areas 502 are arranged in such a way that they each have at least three fastening openings 510. Between the mounting areas 502, in particular viewed in the longitudinal direction L, the bending stiffness of the end plate 500 is variable, wherein this decreases in the direction towards the mounting areas 502. This variable bending stiffness can be achieved by the stiffening ribs 520, which extend parallel to the longitudinal direction L.

### LIST OF REFERENCE NUMBERS

1—Fuel cell
9—Fastener or connector
210—Bipolar plate
240—Opening
242—Mounting opening
244—Flow opening
250—Flow groove
252—Flow area
300—Bipolar plate system
310—Sealing element
500—End plate
502—Mounting areas
510—Fixing openings
520—Stiffening ribs
B—Width direction
L—Longitudinal direction
H—Height direction

1. A bipolar plate for a fuel cell,
wherein the bipolar plate extends in a longitudinal direction and in a width direction,
wherein the longitudinal direction and the width direction are perpendicular to each other,
wherein the bipolar plate has a plurality of openings,
wherein the openings have an outer contour,
wherein the outer contours of the openings are each formed by a mounting opening and at least one flow opening,
wherein the mounting opening forms a circular-segment-shaped portion of the outer contour of the opening,
wherein the mounting opening is designed to accommodate a fastener, and
wherein the circular-segment-shaped part of the mounting opening forms at least 51% of a circle.

2. The bipolar plate according to claim 1, wherein the circular-segment-shaped part of the mounting opening forms a maximum of 98% of a circle.

3. The bipolar plate according to claim 1, wherein the bipolar plate has flow grooves in a flow area of the bipolar plate, and
wherein the flow grooves end and/or start in an opening.

4. The bipolar plate according to claim 3,
wherein the flow grooves are formed by straight and rectangular sections, and/or
wherein the flow grooves run in a meandering pattern.

5. A bipolar plate system comprising:
a bipolar plate that extends in a longitudinal direction and in a width direction,
wherein the longitudinal direction and the width direction are perpendicular to each other,
wherein the bipolar plate has a plurality of openings that each have an outer contour; and
a sealing element,
wherein the sealing element rests against the bipolar plate,
wherein the sealing element follows at least in sections the circular-segment-shaped part of the outer contour of an opening.

6. The bipolar plate system according to claim 5, wherein the sealing element projects into an opening of the plurality of openings.

7. The bipolar plate system according to claim 5,
further comprising a plurality of sealing elements,
wherein the sealing elements follow the course of the outer contour of an opening of the plurality of openings at least in sections, and
wherein each of the plurality of openings are each surrounded by an outer contour of a sealing element.

8. The bipolar plate system according to claim 7,
wherein the plurality of sealing elements are fixed to the bipolar plate, and
wherein the sealing element is produced by a screen printing process or by a mould-in-place process.

9. The bipolar plate system according to claim 7,
wherein the plurality of sealing elements are arranged on the bipolar plate such that each sealing element forms a self-contained contour on the bipolar plate,
wherein outer contours of the plurality of openings are each formed by a mounting opening and at least one flow opening, and
wherein the at least one flow opening is arranged within the self-contained contour.

10. The bipolar plate system according to claim 5, wherein the bipolar plate is used for a fuel cell.

11. An end plate for a fuel cell,
wherein the end plate extends in a longitudinal direction and a width direction,
wherein the end plate has two mounting areas spaced apart from one another in the longitudinal direction,
wherein the bending stiffness of the end plate is variable, between the mounting areas, decreasing in the direction towards the mounting areas, and
wherein the end plate has curved stiffening ribs, wherein the curved stiffening ribs extend parallel to the longitudinal direction.

12. The end plate according to claim 11, wherein the mounting areas each include at least one fixed opening configured to receive a fastener that engages a plurality of bipolar plates of the fuel cell.

13. A fuel cell comprising:
a bipolar plate that extends in a longitudinal direction and in a width direction, wherein the longitudinal direction and the width direction are perpendicular to each other, wherein the bipolar plate has a plurality of openings that each have an outer contour;
a sealing element, wherein the sealing element rests against the bipolar plate, wherein the sealing element follows at least in sections the circular-segment-shaped part of the outer contour of an opening; and
an end plate that extends in the longitudinal direction and the width direction, wherein the end plate has two mounting areas spaced apart from one another in the longitudinal direction, wherein at least one of the mounting areas is aligned with the opening having the sealing element, wherein the bending stiffness of the end plate is variable between the mounting areas, decreasing in the direction towards the mounting areas, and wherein the end plate has curved stiffening ribs that extend parallel to the longitudinal direction.

14. (canceled)

15. (canceled)
